(19) United States
(12) Patent Application Publication
(10) Pub. No.: US 2005/0149280 A1
(43) Pub. Date: Jul. 7, 2005

(54) Remote battery discharge testing method and apparatus

(75) Inventors: Aditya Mohan Sharma, Richardson, TX (US); Aaron Brooks Cardenas, Dallas, TX (US); Jon August Brenner, Lewisville, TX (US); Iftekhar Hasan, Richardson, TX (US)

Correspondence Address: CARR LAW FIRM, L.L.P., 670 FOUNDERS SQUARE, 900 JACKSON STREET, DALLAS, TX, 75202, US

(73) Assignee: Valere Power, Inc., Richardson, TX (US)

(21) Appl. No.: 10/752,829

(22) Filed: Jan. 6, 2004

(51) Int. Cl. G06F 19/00

(52) U.S. Cl. 702/63

(57) ABSTRACT

Disclosed is an apparatus for providing remote testing and monitoring of equipment backup batteries at the location of the batteries. The testing can be accomplished upon command from a remote terminal or remote agent as well as in accordance with predetermined parameters programmed into a processor at the remote site. The test is accomplished using the normal site load while reducing the amplitude of the DC (direct current) output voltage, obtained from an AC (alternating current) rectifier used at the site, from a battery charging “float” level amplitude during the duration of the test. The discharge curve obtained during the test is compared with previous and/or standardized curves to ascertain the condition of the battery tested and/or the likelihood of near future failure of the battery tested.

### TECHNICAL FIELD

The invention relates to providing a means for obtaining an indication of the operational condition of a battery located at a remote location.

### BACKGROUND

Batteries are used in backup situations for temporary absence of normally supplied alternating current power. While such backup batteries are used for many applications, such as emergency lighting in buildings and so forth, a substantial number of backup batteries are used in connection with the telecommunications industry. When normally supplied alternating current electric power fails, it is very important that telephones and other communication equipment remain operable. The communications equipment is typically scattered throughout the area being serviced and the number of battery sites used for backup can number in the thousands.

While useful battery life is typically from 2 to 10 years, a battery can fail suddenly at anytime. One approach to minimizing backup power failure has been to replace all backup batteries when they have been used for 2 years. Such an approach is not only expensive from a cost of battery standpoint, but is also expensive from the standpoint of the wages paid to technicians used to deliver and replace the batteries. Such an approach does not eliminate the potential problems associated with premature failure of a battery in less than 2 years.

It is known in the prior art that a visual presentation in the form of a curve can be generated illustrating the voltage of a battery, that has been placed under loaded conditions, over a period of time. If such a curve is compared with the form of a similarly generated curve from a known good battery, or alternatively with a curve previously generated from the battery under test, a reasonably good determination can be made as to the condition of the battery and thus of the likelihood of failure of the battery in the near future. It is also known that the form of the curve and the values of the curve are both temperature and load sensitive. Thus when any comparisons, of prior and present curves are made, any differences in battery temperatures and battery loads must be taken into consideration.

It is known in the prior art to install wiring from a central location to a remote set of batteries and test the batteries by loading the batteries with a precision electronic load and measuring the voltage and current under such condition. This test is known in the industry as a conductance measurement. Such a test setup is not widely used because of the cost of installation of both wiring and circuitry as well as problems of maintenance.

There is therefore a need to be able to devise a method whereby battery condition testing can be performed at each remote site under predetermined conditions and/or situations not subject to continuous supervision by a centrally situated entity. There is a further need for the capability of apparatus whereby a central entity could, at anytime, ascertain the condition of any specific battery and/or alternatively be informed by circuitry at the remote site that a given battery has a high probability of failure in the near future.

### SUMMARY OF THE INVENTION

The present invention comprises using a CPU (computer or central processing unit) in combination one or more batteries at remote locations to maintain a history of battery tests that can be retrieved over a communication path by an interested entity at a different location.

### BRIEF DESCRIPTION OF THE DRAWINGS

For a more complete understanding of the present invention, and its advantages, reference will now be made in the following Detailed Description to the accompanying drawings, in which:

FIG. 1 is a block diagram of a remotely situated backup battery monitoring, testing and reporting system;

FIG. 2 is a flow chart representative of the steps followed by computer software, at a battery test site, used in conjunction with interaction with remote agent terminals or computers;

FIGS. 3 and 4 comprise a flow chart representative of the steps followed by controller computer software, at a battery test site, in conjunction with collecting and distributing battery discharge test (BDT); and

FIG. 5 comprises a graph representing discharge curves of good and depleted batteries.

### DETAILED DESCRIPTION

In the remainder of this description, a processing unit (PU) may be a sole processor of computations in a device. In such a situation, the PU is typically referred to as a CPU (central processing unit).

In the following discussion, numerous specific details are set forth to provide a thorough understanding of the present invention. However, those skilled in the art will appreciate that the present invention may be practiced without such specific details. In other instances, well-known elements have been illustrated in schematic or block diagram form in order not to obscure the present invention in unnecessary detail. Additionally, for the most part, details concerning network communications, electro-magnetic signaling techniques, and the like, have been omitted inasmuch as such details are not considered necessary to obtain a complete understanding of the present invention, and are considered to be within the understanding of persons of ordinary skill in the relevant art.

It is further noted that, unless indicated otherwise, all functions described herein may be performed in either hardware or software, or some combination thereof. In a preferred embodiment, however, the functions are performed by a processor, such as a computer or an electronic data processor, in accordance with code, such as computer program code, software, and/or integrated circuits that are coded to perform such functions, unless indicated otherwise.

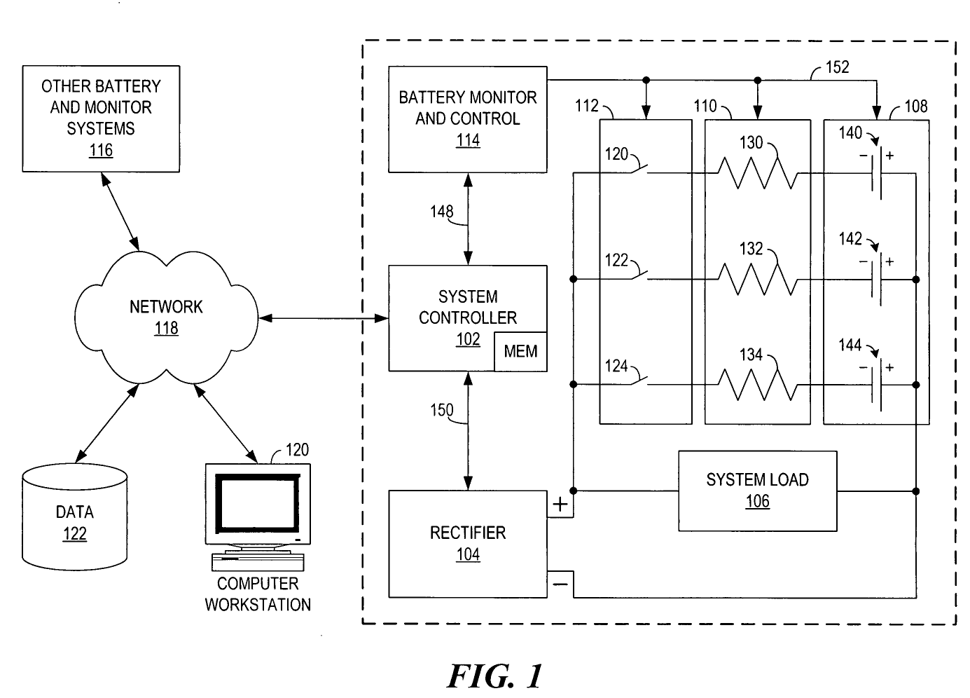

In FIG. 1 a dash line block 100 encloses the components utilized in monitoring and controlling a set of batteries at a given remote location. Within block 100 there is shown a system controller 102 that provides instructions to an AC to DC rectifier 104 used to supply power in typical or normal circumstances to a load 106. This load, in a typical or preferred embodiment of the invention, comprises telecommunication equipment and backup batteries for that equipment. Three batteries are shown within a battery block 108. For a majority of telecommunications loads, a nominal voltage of 48 volts is required. The power supplied, by rectifier 104, under normal circumstances comprises a voltage which is slightly higher than the nominal voltage of the backup batteries. This voltage is often referred to as a “float” voltage. Thus the battery representations within block 108 may actually comprise a plurality of batteries such as four 12 volt batteries connected in series. Such a series connection is often described in the art as a “string of batteries”. A current measuring block is designated as 110 wherein the current going into or out of each battery in block 112 can be measured. A block 112 comprises a set of switches for connecting or disconnecting specific ones of the batteries within block 108 for testing, replacement and so forth. The components within blocks 108, 110 and 112 are connected in series such that each battery is connected in across the output of the rectifier 104 and in parallel with load 106 via a switch and a current measuring device. A battery monitor and control block 114 is interconnected to blocks 102, 108, 110 and 112 for supplying signals to and receiving signals from these blocks. Further remote loads and associated backup batteries, including monitoring equipment such as shown within block 100, is represented by a block 116. A network 118, such as the internet, may be used to transmit data and instructions between the remote sites and one or more computers or workstations 120 as well as data storage facilities represented by a block 122.

Although not shown specifically, a technician at the site, represented by block 100, may have a terminal interconnected to controller 102 to provide instructions to or receive data from controller 102. Such a terminal may be connected through the network 118, such as by satellite or other means, or connected directly to controller 102.

For ease in describing the operation of the system, the switches within block 112 will be designated as 120, 122 and 124. Switch 120 is shown connected to and in series with a current measuring resistor 130 within block 110 and a battery 140 within block 108. In a similar manner, a switch 122 is connected is series with a current measuring resistor 132 and a battery 142.

The system controller 102 plays a central role in the overall battery test and management scheme. This controller 102 will typically be equipped with an intelligent processor and associated memory. This memory is represented by a sub-block within 102 labeled MEM. The controller 102 is used to initiate any battery test by sending an appropriate control signal to other system slave components such as block 104, 108, 110, 112 and 114 via communication links designated as 148, 150 and 152. For the duration of any test, the controller 102 receives data or information from the slave devices through one of the illustrated system communication buses. The system controller 102 processes this information in real time for calculation of various battery performance related parameters. The controller 102 also communicates with one or more remote monitoring stations, shown as block 120, via the user's network 118 in real time. The controller 102 can also store certain information in controller memory (not specifically shown) for future access by a local or remote terminal. In addition, the controller 102 can abort or stop the test based on the occurrence of certain pre-defined conditions detected during the test. These conditions include, completion of test time, occurrence of any system alarm including those generated by the test, or user abort from the local or remote terminal.

The rectifier block 104 typically comprises several AC/DC converters other wise known as rectifiers. These rectifiers, typically in combination with a smoothing filter, convert the incoming AC input line to an isolated DC output. The value of the output DC voltage will normally be of a value which will be adequate for powering the electronic equipment represented by block 106. In addition to that, the rectifier block 104 normally provides a continuous charge current to the batteries 108. The system output voltage is maintained at a level to provide adequate charging of the batteries with out causing any undesirable stress to the batteries. This set point voltage level is also known a “float” voltage. Under normal conditions, the system controller 102 supplies a command to the rectifier block 104 to set the appropriate float voltage and monitors for any special condition existing in them. At the beginning of the battery test, the system controller 102 operates to set the output voltage of the rectifier block 104 at a level, which is considerably lower than the level at which the batteries were floating. This lower voltage setpoint forces the batteries 108 to take over the system load. The testing will normally be of a specific battery such as 142. In such a situation, the switches 120 and 124 will be commanded to open and the switch 122 will be closed. This starts the battery discharge cycle for the battery test of battery 142. Because the rectifier 104 is still providing an output voltage, although at a lower than normal level, the system load 106 is not exposed to the possibility of losing DC power in the event of a catastrophic problem such as the battery 142 being damaged to the extent that it cannot support the load.

The battery monitoring unit 114 operates to continuously monitor certain battery parameters such as battery voltage and current. The information obtained during the monitoring operation is provided to the system controller 102 during battery test for further processing, storage, and transmission to the remote terminal(s) represented by block 120. In addition to monitoring, the battery control unit can disconnect any or all battery strings, of block 108, from the system load 106 though the disconnect switches or contactor shown in block 112.

The system load block 106 represents the naturally occurring load on the DC power plant or rectifier 104. The battery discharge test utilizes the load represented by block 106 to “load” or discharge the batteries for a pre-defined time. This test is used to ascertain a battery parameter known in the art as a measurement of “amp-hour” capacity. As will be realized, the system load can vary during different hours of operation of the system. Thus a preferable time to perform any battery testing is during a period when past history has shown the system load to be fairly uniform.

As indicated previously, the discharge pattern of a battery will vary based on the state of the battery cells. Further, environmental factors such as battery temperature and instantaneous current drawn will have an effect on the discharge pattern of the battery being tested. Thus the system controller 102 must be equipped to be informed to various conditions during the test and compensate for these factors when attempting to ascertain the condition of the battery for which testing has just been completed.

To minimize the load on the network, the controller 102 will typically retain a history of the discharge pattern of each battery at a given remote location. Such a history will facilitate the determination of whether the battery is approaching a state wherein the battery tested is likely to fail in the near future.

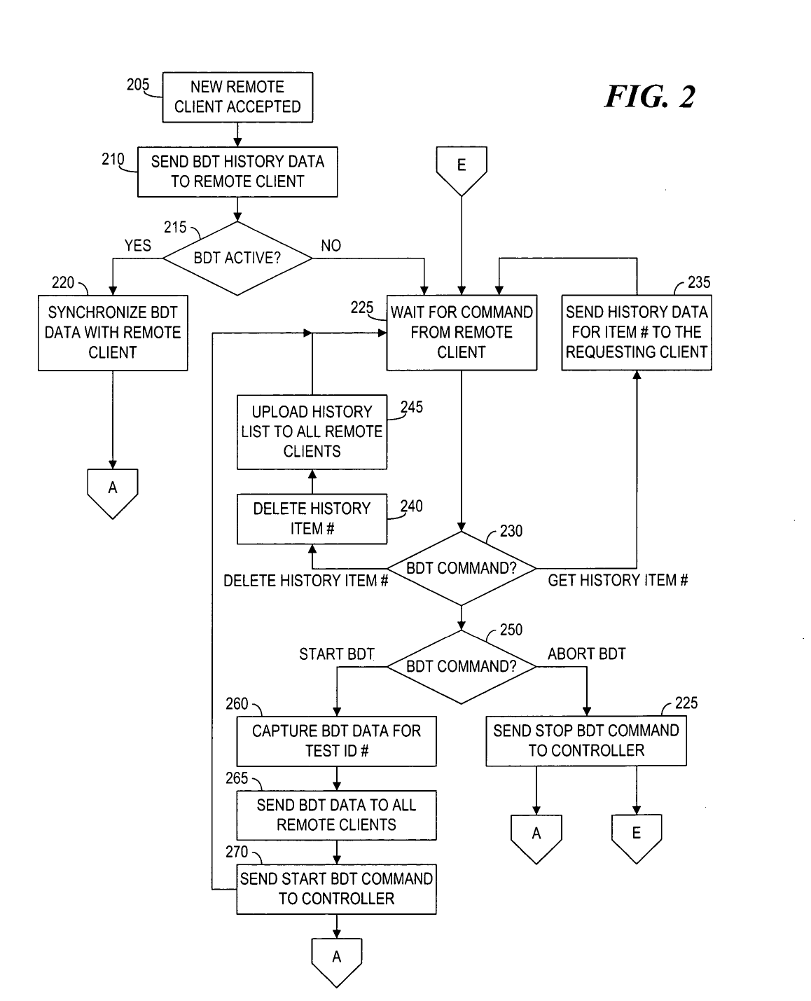

Referring now to FIG. 2, a block 205 represents a checking by the software as to whether or not a new computer or remote agent 120 has been connected to the system. Any reference to a “remote agent” is intended to include any computer that is remote from a battery test site and is set up to review BDT (battery discharge test) data. In a given situation, there may be only one remote agent or there may be many. Further a maintenance technician, visiting a battery site, may connect to the batter test computer at the site to review recent tests and would be considered a remote agent even though physically at the site.

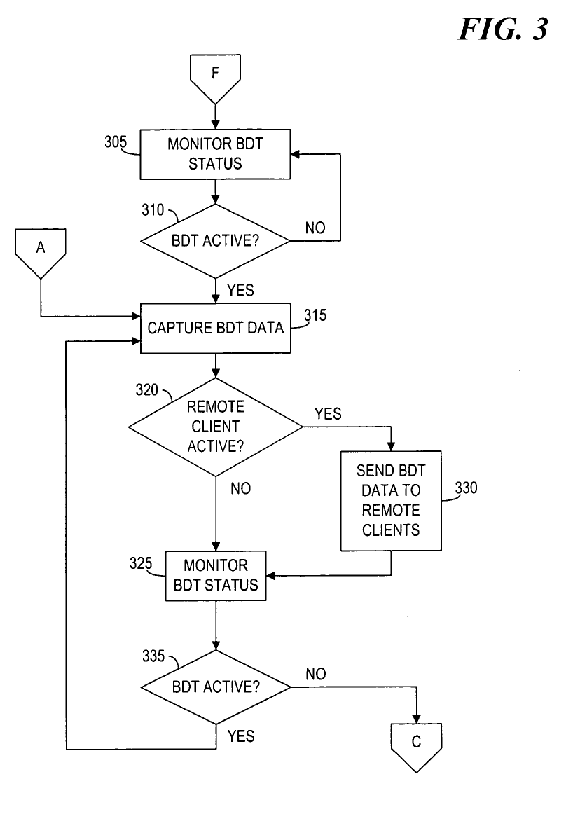

After a new remote agent is accepted in a block 210, existing BDT history is sent to the agent in accordance with the step of block 210. The next step, in a decision block 215, is to ascertain if a BDT is presently active. In other words, “is a test presently being performed?” If yes, the BDT data presently being obtained is synchronized with any new remote agent(s). The next step, beyond block 220, is to input A of FIG. 3. If there is no presently active BDT, the next step after block 215 is to wait for a command from a remote agent as set forth in a block 225. Examples of two commands are shown at the output of a decision block 230. A command could request that the data for a given BDT test be sent to a given remote agent. This is set forth in a block 235. After the data for that given history item is sent, the process returns to block 225 and awaits further commands. Another potential command is the deletion of a given BDT. This would again be referred to as a given history item # (number). The given BDT would be deleted as set forth in a block 240 and an altered history list of the remaining BDTs would be sent as set forth in a block 245 before returning to block 225.

A decision block 250 represents the interpretation of two additional commands that may be received from a remote agent. An abort BDT command would cause the software to send a STOP BDT command to the BDT controller as set forth in a block 255. The command is sent to a B input of FIG. 3 and also a return is made to block 225 to await further commands from remote agents.

A start BDT command, from a remote agent, would cause a test ID# to be assigned as set forth in a block 260 and prepare all remote agents to receive data for this new test as set forth in a block 265. A start BDT command would be sent to the controller 102, from a block 270 to an A input of FIG. 3. Also the software of FIG. 2 would return to block 225 to await further received commands from remote agents.

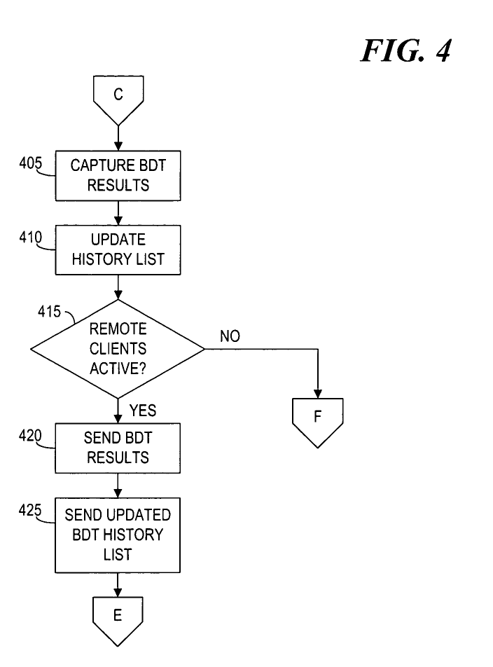

Reference will now be made to the controller software steps of FIGS. 3 and 4 in combination with the remote agent interaction software of FIG. 2. A block 305 monitors the status of any BDT action or activity. As long as there is no activity, a decision block 310 causes a looping effect. When a BDT is activated, due to a command from a remote agent 120 or due to the occurrence of predetermined conditions set in the controller program, the step 310 proceeds to a block 315 for capturing generated BDT data by placing it in some type of memory. This memory may be typically flash memory or a hard drive. It may be noted that the block 315 may also be entered from blocks 220 or 270 of FIG. 2.

A check is made, in a decision block 320, as to whether or not one or more remote agents 120 are active and wish to receive the data being generated. If not, a monitoring step represented by a block 325 is entered. The step 325 is essentially the same as the step of block 305. Then a determination is made, in block 320, that one or more remote agents are active, data is sent to the remote agent as set forth in a block 330, as it is being generated or at the completion of the test in accordance with software design or request of the remote agent operator. A decision block 335 maintains a check on the BDT activity and maintains a closed loop back through the block 315 for the duration of the test. It may be noted that the BDT status step of block 325 may also be entered from block 255 of FIG. 2 to terminate the BDT.

When BDT activity ceases, due to completion of the test or termination at the request of a remote agent, the process proceeds to a block 405 to capture or retrieve all the stored data for the most recent test. As set forth in a block 410, a history list, of all recently performed tests whose data is still contained in memory, is updated. A check is then made, in a decision block 415, to ascertain if any remote agents 120 are presently active. If not, the controller software returns to monitoring any BDT status in block 305. On the other hand, if the remote agent is still active, the BDT results are sent to the remote agent, as set forth in a block 420. Then, as set forth in a block 425, an updated BDT history list is sent to the remote agent before returning to block 225 of FIG. 2 to await further commands.

Although not specifically shown, in a preferred embodiment, the controller box 100 at a battery site will include a switch or other manually operated means for an on site technician to activate a BDT with using a remote agent computer terminal. The controller box will also have an output signal or display to inform the technician whether the BDT ascertained the batteries to be good or to have failed the test.

If a failure indication is provided in response to a manually activated test, the technician may request further testing, via a remote agent terminal, to obtain more information as to which battery has failed or alternatively a graphical display of the specific data that resulted in the failure indication.

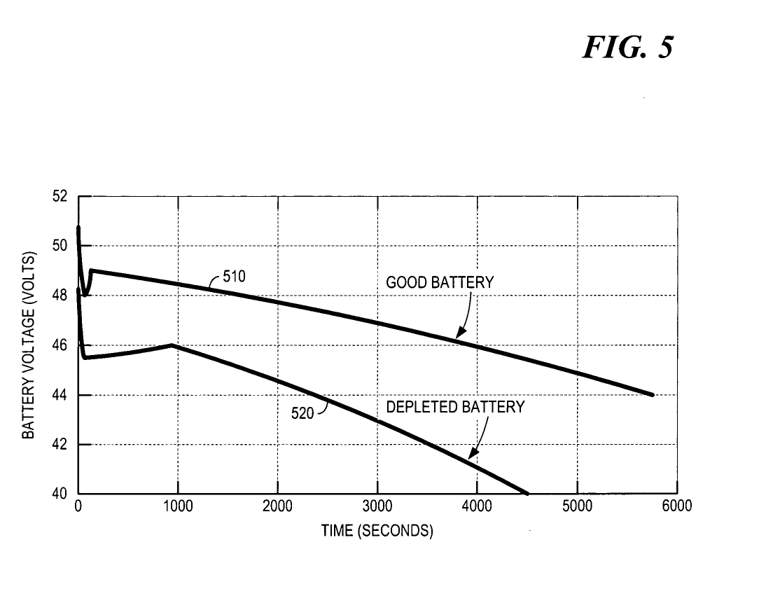

A given history item comprises a set of data including temperature of the batteries at the time of the BDT, the current being drawn by load 106 and a series of battery voltages and the time from the start of the BDT that the battery voltage was ascertained. In FIG. 5 a curve 510 illustrates a graphical representation of the battery voltages obtained over a period of time for a good battery. The test is typically run for either a given time period or until the battery voltage drops to a predetermined value. For a set of batteries generating 48 nominal volts, the predetermined value might be 44 volts as shown. A “good” battery will typically supply more than its rated voltage at the start of a discharge test. As shown, the battery represented by curve 510 starts at 51 volts and drops quickly to slightly more than 48 volts when the normally supplied maintenance voltage supplied by rectifier 104 is lowered to a standby voltage, such as for example 40 volts. A good battery quickly recovers to a higher voltage. As shown the recovery is to about 51 volts at about 100 seconds after the start of the test. The good battery voltage then declines at a substantially constant rate for a little more than 5000 seconds until the test is completed.

A curve 520 represents a graph of a depleted battery that needs to be replaced. The voltage of the depleted battery drops far below the rated value of the battery as soon as a load is applied. As set forth above, the load is applied by dropping the voltage output by rectifier 104 to a given standby voltage. As shown, the initial drop of the depleted battery is to about 45.5 volts after about 50 seconds. Rather than rising sharply, the output voltage of a depleted battery either rises minimally or does rise at all. As shown, the battery represented by curve 520 rises to 46 volts after about 1000 seconds and then declines rapidly to the predetermined set value of 44 volts after about 2300 seconds. For the purposes of illustration, the curve is shown proceeding to the 40 volt output of rectifier 104 at about 4600 seconds.

The criteria used for replacing a battery can be set to any of various factors or parameters. It can be the time for it to reach the predetermined minimum, taking into account the temperature and load current for a given test. As may be noted the decaying voltage slope for the battery represented by curve 520 is much steeper than the good battery from 1000 seconds until the set voltage of 44 volts is reached. Thus the slope of battery voltage over time can be used. Also the voltage after a nominal time into the test, such as 200 seconds can be used as an indication of when to replace batteries. All of the aforementioned criteria may be used separately or in some combination for used or supposedly good or new batteries. If a battery being tested has a history of tests stored in the MEM section of controller 102, the decline in voltage from any previous test may also be used in ascertaining that a given battery needs to be replaced.

In summary, the system controller 102, in each the remote locations, periodically tests each of the battery strings in block 108. This test is referred to above as a BDT. A BDT will typically be performed on some type of schedule such as daily, weekly or monthly.

A discharge curve obtained, as a result of the BDT, is compared with previously obtained curves, stored in the memory portion of controller 102, as well as compared to a standardized curve for batteries of this type. Compensation is made for environmental conditions that will affect the discharge curve such as temperature of the battery. The data obtained in each series of tests is transmitted through network 118 to a centralized data storage block 122. The controller 102 will also run a test when the battery monitor detects an anomaly such as a sudden change in current to an individual battery string. Such a change may be due to an open condition in a cell or a shorted condition in a cell. When one or more battery strings in block 108 is ascertained to have a discharge curve falling outside predetermined parameters, the controller 102 transmits this information to an administrator at a centrally located computer workstation 120. This information is also available to any other remote agent that is presently actively connected to the controller 102 at a specific battery site 100. The administrator user at workstation may request more tests or may simply dispatch a technician to the site of the failed battery to replace same.

It may be noted that when the test is performed in response to an internal schedule, the results are merely stored in memory and a history list is updated unless the controller software detects that one or more remote agent(s) are actively connected and communicating with the remote battery site controller. When the controller software detects that a remote agent is active, whether or not the remote agent has specifically requested a BDT, the latest BDT data is supplied to the remote agent as well as the most recent history list.

As mentioned above, the remote agent may also abort a presently running BDT, delete specific BDTs from the battery site controller memory and retrieve data relating to specific prior BDTs. After retrieval of BDT data, software on the remote agent computer may be used to display the data in graph form whereby action may be initiated to minimize any battery problems that could occur at the battery site.

Although the invention has been described with reference to a specific embodiment, the description is not meant to be construed in a limiting sense. Various modifications of the disclosed embodiment, as well as alternative embodiments of the invention, will become apparent to persons skilled in the art upon reference to the description of the invention. It is therefore contemplated that the claims will cover any such modifications or embodiments that fall within the true scope and spirit of the invention.

1. A method of obtaining remotely located operational battery condition data comprising:
removing charging power from a remotely located battery;
checking the voltage versus time characteristic;
comparing the obtained voltage versus time characteristic against one of a previously obtained voltage versus time characteristic for that remotely located battery or a known good battery of the same type as said remotely located battery; and
providing a warning signal when the comparison exceeds predetermined limits.

2. A method of checking the operational condition of a battery at a remote location comprising:
maintaining a set of computer generated records of latest and prior battery condition test results at a site in proximity to a battery being tested; and
retrieving at least some portion of said set of test results, over a communication path, to a location remote from the location of the battery being tested.

3. A method of monitoring the operational condition of a battery at a remote location comprising:
maintaining a set of computer generated records of latest and prior battery condition test results at a site in proximity to a battery being tested;
comparing the latest record and at least one prior record of test results for differences; and
sending a warning over a communication path to an entity remote from the battery site when a predetermined set of differences is ascertained upon comparison.

4. The method of claim 3 wherein:
the battery condition test is obtained by measuring and recording battery voltages at a plurality of voltage values over a period of time when the battery is not being charged.

5. The method of claim 3 wherein:
the battery condition test is obtained by measuring and recording battery voltages at a plurality of rate of change of voltage values over a period of time when the battery is not being charged starting immediately after charging of a battery is stopped.

6. A method of ascertaining the condition of a battery situated at a remote location from a user comprising:
ascertaining and storing data representing a set of battery voltages at said remote location, while the battery is under a load condition, over a period of time when charging power is not being supplied to said battery for each time that charging power is removed from said battery whereby a history of results is maintained at said remote location;
operationally connecting to a remote computer, via a communication path;
retrieving at least the most recent set of data and one prior set of data;
generating at least one of a graphically visible presentation for each set of data retrieved; and
comparing the presentations presented to determine the condition of the battery as of the latest data collected.

7. A method of checking the operational condition of a battery at a remote location comprising:
maintaining a set of computer generated records of latest and prior battery condition test results at a site in proximity to a battery being tested;
comparing the latest obtained record against one of the previously records; and
providing a warning signal over a communication path, to an authorized entity, when differences ascertained in the comparing exceeds predetermined limits.

8. Apparatus for providing remote testing of backup batteries used in connection with a load normally powered by a rectified AC (alternating current) power source comprising:
backup battery means;
controllable DC (direct current) voltage supply means operable to normally supply a float voltage to a load and to said backup battery means and, upon command, to supply a lesser amplitude voltage;
control and monitor means operable monitor the voltage of said backup battery means when the battery is being discharged after the voltage supply means to caused to supply said lesser amplitude voltage.

9. The apparatus of claim 8 wherein:
said backup battery means comprises a plurality of battery strings;
each battery string includes a disconnect means; and
said control and monitor means is operable to disconnect all batteries at the location other than the battery being tested for the duration of a test sequence.

10. The apparatus of claim 8 wherein:
said control and monitor means is operable to measure the current and voltage output of a battery being tested as well as environmental conditions that affect the discharge curve of a battery being discharged.

11. The apparatus of claim 8 wherein:
said control and monitor means is operable to maintain a record of prior battery tests whereby a comparison may be used to predict the likelihood of near future failure of the battery tested.

12. The apparatus of claim 8 wherein:
said control and monitor means is operable to normally test batteries in accordance with predetermined conditions; and
said control and monitor means is connected, via a communication network, to a central terminal, remote from the battery site, whereby instructions may be received from said central terminal to perform additional battery tests outside the scope of said predetermined conditions.

13. A computer program product for checking the operational condition of a battery at a remote location, the computer program product having a medium with a computer program embodied thereon, the computer program comprising:
computer code for maintaining a set of computer generated records of latest and prior battery condition test results at a site in proximity to a battery being tested; and
computer code for retrieving at least some portion of said set of test results, over a communication path, to a location remote from the location of the battery being tested.

14. A computer program product for ascertaining the condition of a battery situated at a remote location from a user, the computer program product having a medium with a computer program embodied thereon, the computer program comprising:
computer code for ascertaining and storing data representing a set of battery voltages at said remote location, while the battery is under a load condition, over a period of time when charging power is not being supplied to said battery for each time that charging power is removed from said battery whereby a history of results is maintained at said remote location;
computer code for operationally connecting to a remote computer, via a communication path;
computer code for retrieving at least the most recent set of data and one prior set of data;
computer code for generating at least one of a graphically visible presentation for each set of data retrieved; and
computer code for comparing the presentations presented to determine the condition of the battery as of the latest data collected.

15. Apparatus for ascertaining the condition of a battery at a site remote from a computer terminal comprising:
a battery operationally connected to a load;
a controller configured to retrieve test data comprising battery voltage, current and time of test data retrieval;
a remote agent terminal operable to display a graph indicating a battery's condition based upon voltage and current data obtained over a period of time;
test actuation means, operable, in response to either one of a remote agent command or a battery site test schedule, to initiate a BDT (battery discharge test)
storage means including data pertaining to past BDTs;
comparison means configured to determine present battery condition in relation to at least one of,
past BDTs on the battery presently being tested, and
stored data obtained from known good and failed batteries; and
communication means operable to transmit BDT data to a requesting remote agent.
